(19) United States
(12) Patent Application Publication
(10) Pub. No.: US 2010/0173185 A1
(43) Pub. Date: Jul. 8, 2010

(54) Battery pack assembly for an intrinsically safe device

(76) Inventors: James Norgaard, Marblehead, MA (US); Gary Richard, Brookline, MA (US); Joseph A. Rebeiro, Freetown, MA (US)

Correspondence Address: Iandiorio Teska & Coleman, 260 Bear Hill Road, Waltham, MA, 02451, US

(21) Appl. No.: 12/592,146

(22) Filed: Nov. 19, 2009

Related U.S. Application Data
(60) Provisional application No. 61/200,269, filed on Nov. 26, 2008.

(51) Int. Cl. H01M 10/50; H01M 10/04

(52) U.S. Cl. 429/120; 29/623.1

(57) ABSTRACT

A battery pack assembly for an intrinsically safe device including a housing assembly. A pair of opposing end caps coupled to the housing assembly is configured to align a plurality of cells in a predetermined orientation. A potting compound is disposed in the housing which completely encapsulates all the surfaces of the plurality of cells and provides a uniform thickness of potting compound about the cells. The potting compound is configured to dissipate heat generated by an internal short of one of the plurality of cells and/or heat generated by over-charging or under-charging one of said cells such that the temperature of any external surface of the battery pack assembly does not exceed a predetermined temperature and prevents a venting of one of the plurality cells within the potting compound.

### RELATED APPLICATIONS

This application claims benefit of and priority to U.S. Provisional Application No. 61/200,269 filed Nov. 26, 2008 under 35 U.S.C. §§119, 120, 363, 365, and 37 C.F.R. §1.55 and §1.78, incorporated herein by this reference.

### FIELD OF THE INVENTION

This invention relates to a battery pack assembly for an intrinsically safe device.

### BACKGROUND OF THE INVENTION

Portable emissions monitoring devices, such as FID devices, gas chromatography devices, photoionization detectors, and the like, may be used to detect volatile organic compounds (VOCs) and/or hazardous organic compounds produced from petro-chemical facilities, chemical plants, paint facilities, and similar type facilities. Such portable devices require a battery pack to provide the needed power to operate the devices.

Emissions monitoring devices need to be certified as intrinsically safe (IS) before they can be used. To be certified as IS, emission monitoring devices need to meet the requirements of at least Underwriters Laboratory (UL) 913 standard for safety for intrinsically safe apparatus for use in class I, II, and II, division 1, hazardous (classified) locations, Fifth Edition, dated February 1997, incorporated by reference herein.

Underwriters Laboratory is a nationally approved testing laboratory which sets the standards and gives IS certification to emissions monitoring devices. OSHA is the governmental agency which monitors the UL standards and accredits national laboratories, such as Underwriters Laboratories, Intertek, and the like, as competent and capable of evaluating emissions monitoring devices to determine if they meet the requirements of UL 913. If emissions monitoring devices meet these standards, the nationally recognized laboratory provides an Intrinsic Safety certification.

The T4 temperature rating specified in UL 913 mandates that the battery pack must be able to withstand two types of fault conditions and ensure all surfaces of the battery pack that may contact the environment do not exceed a predetermined temperature, e.g., about 95° C. above ambient temperature, or greater than about 135° C. The two types of fault conditions may include an internal short in the cell (battery) and a common electrical short caused by over-charging or under-discharging the battery pack. An internal short may cause one of the cells of the battery pack to vent (explode). Therefore, the battery pack is preferably be capable of preventing or sustaining any eruption of one of the cells in the battery pack.

### SUMMARY OF THE INVENTION

This invention features a battery pack assembly for an intrinsically safe device including a housing assembly. A pair of opposing end caps coupled to the housing assembly may be configured to align a plurality of cells in a predetermined orientation. A potting compound may be disposed in the housing which completely encapsulates all the surfaces of the plurality of cells and which provides a uniform thickness of potting compound about the cells. The potting compound may be configured to dissipate heat generated by an internal short of one of the plurality of cells and/or heat generated by over-charging or over-discharging one of the plurality of cells such that the temperature of any external surface of the battery pack assembly does not exceed a predetermined temperature and prevents a venting of one of the plurality cells within the potting compound.

In one embodiment, each of the opposing ends may include a stepped recess. The stepped recess may form a cavity proximate the ends of each of the plurality of cells configured to receive the potting compound such that the potting compound completely encapsulates the ends of each of the plurality of cells. The end caps may be made of a non-conductive material. The predetermined temperature may include a T4 temperature limit specified in UL 913. The predetermined temperature may be about 95° C. above ambient temperature and/or about 135° C. The housing assembly may include a housing securably attachable to the end caps and a cover. One or more resistors may be coupled to one of the plurality of cells configured to minimize the energy output of the plurality of cells in the event of a short circuit to an external device coupled to the battery pack assembly. One or more fuses may be coupled to one of the plurality of cells configured to prevent an energy output from any of the plurality of cells in the event of a short circuit to an external device coupled to the battery pack assembly. The battery pack assembly may meet the requirements of a UL 913. Each of the plurality of cells may meet the requirements of UL 913. Each of the plurality of cells may be made of nickel cadmium. The plurality of cells may include six cells. The intrinsically safe device may include a flame ionization detector device. The intrinsically safe device may include a gas chromatography device. The intrinsically safe device may include a photoionization device.

This invention also features a battery pack assembly for an intrinsically safe device including a housing assembly. A pair of opposing end caps may be coupled to the housing assembly. Each end cap includes a stepped recess configured to align a plurality of cells in a predetermined orientation. A potting compound may be disposed in the housing which completely encapsulates all the surfaces of the plurality of cells and which provides a uniform thickness of potting compound about the cells. The potting compound may be configured to dissipate heat generated by an internal short of one of the plurality of cells and/or heat generated by over-charging or under-charging one of said cells such that the temperature of any external surface of the battery pack assembly does not exceed a predetermined temperature and prevents a venting of one of the plurality cells within the potting compound.

In one embodiment, the stepped recess may form a cavity proximate the ends of each of the plurality of cells configured to receive the potting compound such that the potting compound completely encapsulates the ends of each of the plurality of cells.

This invention also features a method for manufacturing a battery pack assembly for an intrinsically safe device including providing a housing assembly. A plurality of cells may be placed between opposing end caps such that the plurality of cells are aligned in a predetermined orientation. The plurality of cells and the opposing end cap may be placed in the housing assembly. A potting compound may be poured into the housing assembly such that the potting compound completely encapsulates all surfaces of the plurality of cells and provides a uniform thickness of potting compound about the cells. The potting compound may be configured to dissipate heat generated by an internal short of one of the plurality of cells and/or heat generated by over-charging or under-charging one of the plurality of cells such as the temperature such that the temperature of any external surface of the battery pack assembly does not exceed a predetermined temperature. The potting compound may be cured for a predetermined amount of time. A cover plate is attached to the housing assembly.

In one embodiment, the method may include the step of forming a stepped recess in each of the opposing end caps. The method may include the step of forming a cavity proximate the ends of each of the plurality of cells configured to receive the potting compound such that the potting compound completely encapsulates the ends of each of the plurality of cells.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a three-dimensional assembly front view showing the primary components of one embodiment of the battery pack assembly for an intrinsically safe device of this invention;

FIG. 1B is a three-dimensional front view showing a fully assembled battery pack assembly for an intrinsically safe device of this invention;

FIG. 2A is a schematic side view showing in further detail the structure of one embodiment of the end caps shown in FIG. 1A;

FIG. 2B is a three-dimensional front view showing in further detail the structure of a stepped recess of one of the end caps shown in FIG. 1A;

FIG. 3 is a three-dimensional front view showing on example of the housing assembly with the plurality of cells in place between the end caps ready to receive a potting compound;

FIG. 4 is a three-dimensional top view showing the potting compound completely encapsulating the plurality of cells shown in FIG. 3;

FIG. 5 is a schematic front view showing one example of a resistor and a fuse connected to the plurality of cells shown in FIG. 1A;

FIG. 6A is a three-dimensional front view showing in further detail the connection between each of the plurality of cells shown in FIG. 1A; and

FIG. 6B is an electrical schematic diagram showing one example of the connection of a resistor and a fuse shown in FIG. 5.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

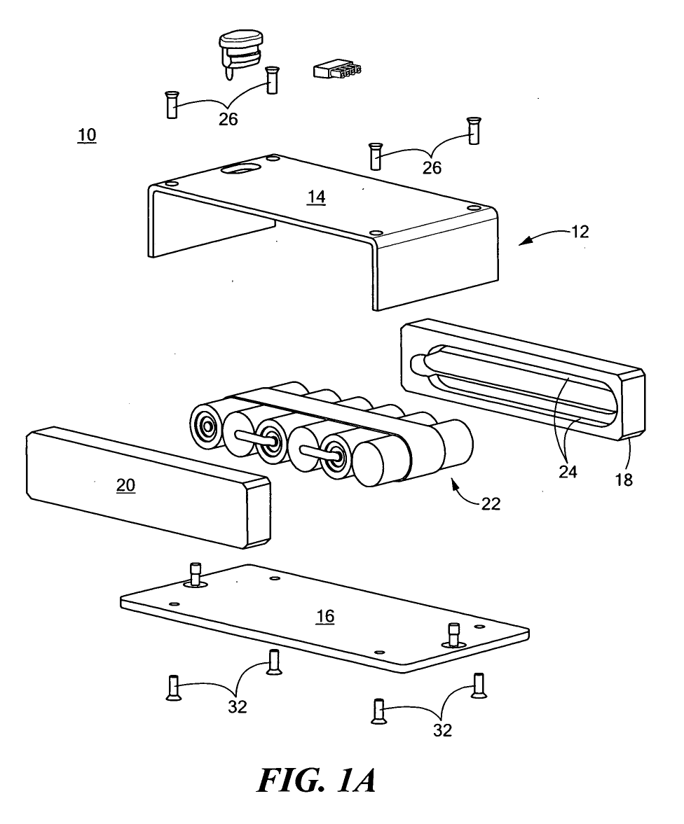

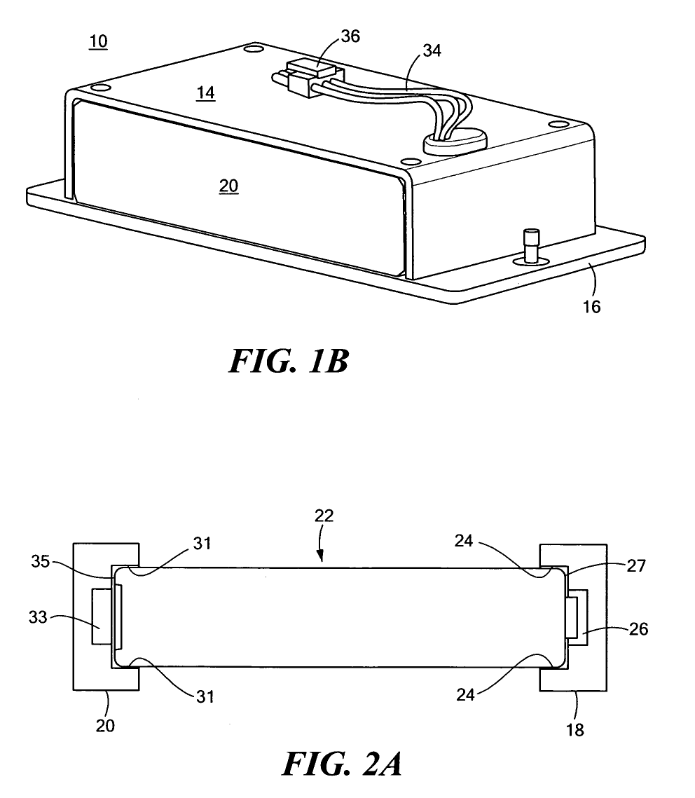

There is shown in FIG. 1A one embodiment of battery pack assembly 10 for an intrinsically safe device of one embodiment of this invention. The intrinsically safe device may include a FID device, a gas chromatography device, a photoionization detector, or similar type emissions monitoring device. Battery pack assembly 10 includes housing assembly 12 which preferably includes housing 14 and cover plate 16. Battery pack assembly 10 also includes a pair of opposing end caps 18 and 20 which are coupled to housing 14. End caps 18 and 20 are configured to align plurality of cells 22 such that they rest in place on a stepped recess in each of end caps 18 and 20. For example, end cap 18 includes stepped recess 24 and end cap 20, FIG. 2A, includes stepped recess 31 which are each designed to receive and hold the plurality of cells 22 in position between end caps 18 and 20 as shown. End caps 18 and 20 are also preferably configured to create a cavity behind the ends of each of plurality of cells 22. In this example, stepped recess 24 of end cap 18 forms cavity 26 proximate end 27 of cells 22. Similarly, stepped recess 31 of end cap 20 forms cavity 33 proximate end 35 of cells 22. FIG. 2B shows in further detail the structure of one embodiment of end cap 18 with stepped recess 24 and cavity 26. Cavities 26 and 33, FIG. 2A, allow a potting compound (discussed below) to completely encapsulate ends 27 and 35 of each of the plurality of cells 22. Preferably, end caps 18 and 20, FIGS. 1A and 2A-2B, are made of a non-conductive material such as a composite of Delrin® and aluminum. In one example, the Delrin® may be a duPont Delrin® acetal resin (polyoxymethylene), available from E.I. DuPont de Nemours & Co., (Wilmington, Del.).

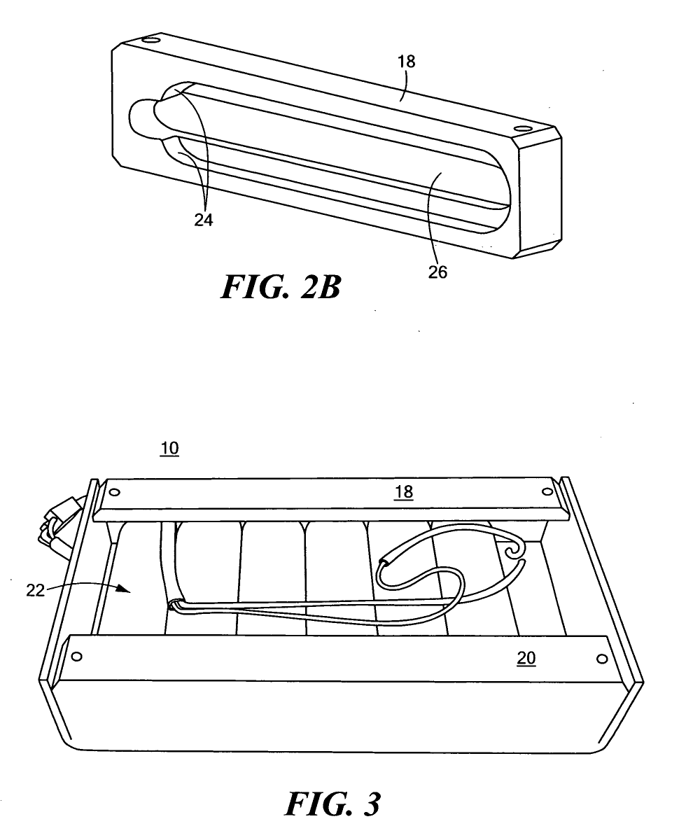

To assemble battery pack assembly 10, FIG. 1A, plurality of cells 22 are placed in position on stepped recesses 24 and 31 of end caps 18 and 20, e.g., as shown in FIG. 2A. End caps 18 and 20, FIG. 1A, are then secured to housing 14 via screws 26. FIG. 3 shows one example of housing assembly 12 with end caps 18 and 20 attached to housing 14 and the plurality of cells 22 and in position on the stepped recess of end caps 18 and 20.

A potting compound, such as a low viscosity, flame retardant, reversion resistant, thermally conductive two-part silicone compound is then poured into housing 14 with end caps 18 and 20 attached thereto. In one exemplary embodiment, the potting compound may be purchased from ITW Polymer Technologies (Montgomeryville, Pa.) e.g., RTVS 8127 PTB (a mixture of aluminum oxide, silicone polymer, silica, crystalline (quartz), and polydimethylsiloxane) and RTVS 8127 PTA (a mixture of aluminum oxide, silicone polymer, silica, crystalline (quartz), siloxanes and silicones, di-Me, Me hydrogen, hydrogen-terminated, and carbon black). The two parts of the potting compound are preferably mixed in 50-50 ratio. About 100 cc of the potting compound is typically disposed in housing 14. Housing 14 and end caps 18 and 20 are preferably set onto a tray which keeps them level, and then subjected to a vacuum oven for about 15 minutes at about 45° C. The vacuum oven process makes sure that there are no voids or air pockets in the potting material. This ensures cells 22 are completely encapsulated by the potting compound. Then, housing 14 and end caps 18 and 20 are removed from the vacuum oven and placed flat at room temperature and allowed to cure. Curing is usually finished overnight.

Once the potting compound has sufficiently hardened, cover plate 16, FIGS. 1A and 3, is secured to end caps 18 and 20 via screws 32. FIG. 1B shows a fully assembled battery pack assembly 10 with cover plate 32 securably attached to housing 14. Electrical conduit assembly 34 with adapter 36 provides for a connection to the emissions monitoring device and provides for recharging plurality of cells 22.

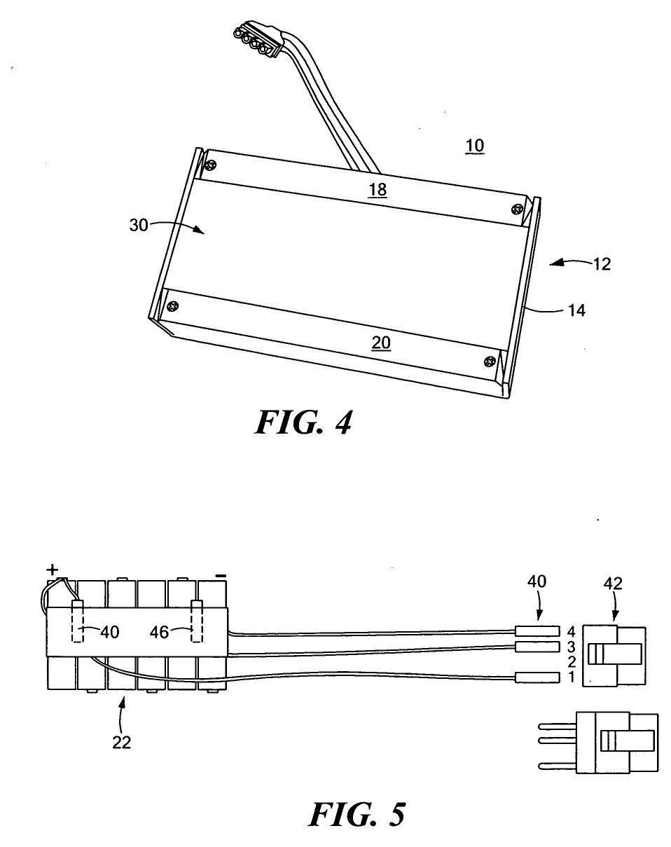

FIG. 4 shows one example of cured potting compound 30 which has completely encapsulated all surfaces of cells 22, FIG. 1A, and provides a uniform thickness of potting compound 30 about cells 22. Potting compound 30 fills cavities 26 and 33, FIG. 2A, such that ends 27 and 35 of each of cells 22 are completely encapsulated with potting compound 30. The thermal conductive characteristic of potting compound 30 quickly dissipates heat generated by a short of one of cells 22 and/or heat generated by overcharging or undercharging one of cells 22 such that housing 14 and cover plate 16 functions as a heat sink. This ensures the temperature of any surface of battery pack assembly 10 does not exceed about 95° above ambient temperature or greater than about 135° C. The result is battery pack assembly 10 meets the T4 temperature rating specified in UL 913. Potting compound 30 prevents venting (eruption) of one of the plurality of cells 22 by conducting the heat away from the source of the short. Potting compound 30 also contains any eruption therein. Potting compound 30 also swells a little to absorb any increase in the size of cells during normal charging and discharging as well as swelling due to a shorted cell.

Preferably, plurality of cells 22 meets the requirements of UL 913. In one example, the plurality of cells 22 are nickel cadmium cells and are certified as intrinsically safe. In one example, plurality of batteries 22 may be purchased from Gold Peak Industries (North America) Inc., (San Diego, Calif.), e.g., Gold Peak Batteries Part No. GP250AFH. In one example, plurality of cells 22 includes six cells.

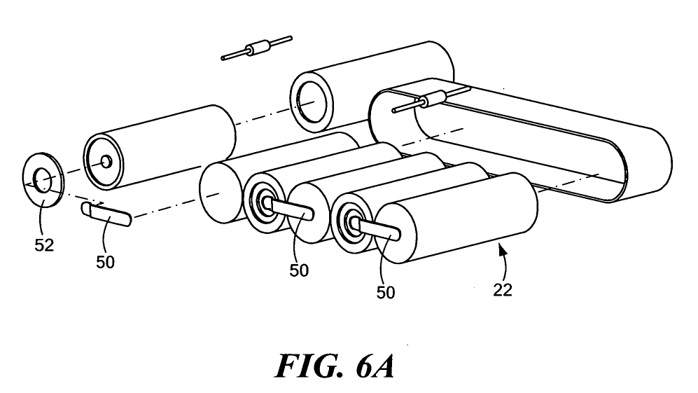

In one embodiment, battery pack assembly 10, FIGS. 1A-4 includes one or more resistors, e.g., resistor 40, FIG. 5, coupled to the plurality of cells 22 which minimizes energy output of the plurality of cells 22 in the event of a short circuit to an external device coupled to the battery pack assembly 10 via contacts 40 and connector housing 42.

Battery pack assembly 10 also preferably includes one or more fuses, e.g., fuse 46, coupled to one of the cells of the plurality of cells 22 to prevent excessive energy output from any of the plurality of cells in the event of a short circuit.

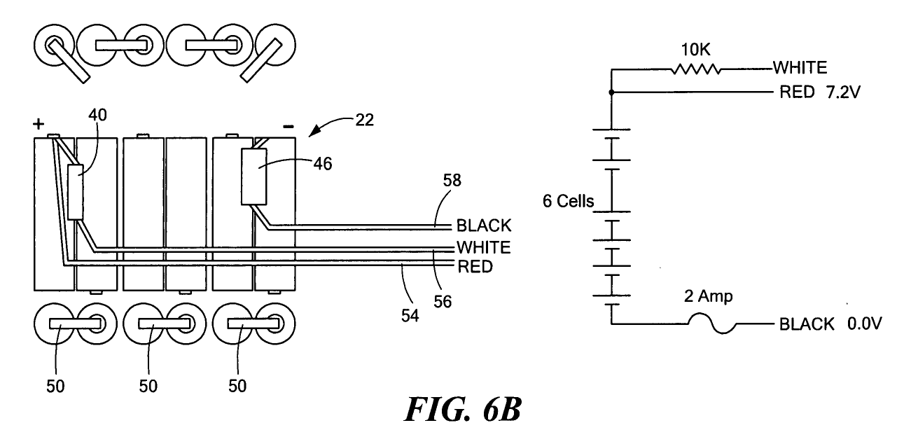

Plurality of cells 22, FIG. 6A, typically includes connectors 50 which connect the positive end of one of the plurality of cells to the negative end of adjacent cell of the plurality of cells 22. An insulating washer, e.g., washer 52, may be placed between connector 50 and the positive end of the respective cell to provide additional insulation and protection against shorting. FIG. 5B shows one example of the electrical connections between three pairs of plurality of cells 22, resistor 40, and fuse 46 connected between red wire 54, white wire 56, and black wire 58, which are coupled to contacts 40, FIG. 5. In one example, battery pack assembly provides about 7.2V at a capacity of about 2500 milliamp hours (ma h) which yield about 12 hours of use for a typical portable emission monitoring device. Battery pack assembly 10 is scalable and may include more or less than six cells which may be larger or smaller to meet the power requirements of various types of intrinsically safe devices and comply with UL 913.

The result is battery pack assembly 10, FIG. 1, of this invention provides an innovative back pack assembly which meets the requirements of UL 913, is easy to use and rechargeable and can provide power for up to about 12 hours to a portable emissions monitoring device.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A battery pack assembly for an intrinsically safe device comprising:
a housing assembly;
a pair of opposing end caps coupled to the housing assembly configured to align a plurality of cells in a predetermined orientation;
a potting compound disposed in the housing which completely encapsulates all the surfaces of the plurality of cells and which provides a uniform thickness of potting compound about the cells; and
wherein the potting compound is configured to dissipate heat generated by an internal short of one of the plurality of cells and/or heat generated by over-charging or over-discharging one of the plurality of cells such that the temperature of any external surface of the battery pack assembly does not exceed a predetermined temperature and prevents a venting of one of the plurality cells within the potting compound.

2. The battery pack assembly of claim 1 in which each of the opposing ends include a stepped recess.

3. The battery pack assembly of claim 1 in which the stepped recess forms a cavity proximate the ends of each of the plurality of cells configured to receive the potting compound such that the potting compound completely encapsulates the ends of each of the plurality of cells.

4. The battery pack assembly of claim 1 in which the end caps are made of a non-conductive material.

5. The battery pack assembly of claim 1 in which the predetermined temperature includes a T4 temperature limit specified in UL 913.

6. The battery pack assembly of claim 1 in which the predetermined temperature is about 95° C. above ambient temperature and/or about 135° C.

7. The battery pack assembly of claim 1 in which the housing assembly includes a housing securably attachable to the end caps and a cover.

8. The battery pack assembly of claim 1 further including one or more resistors coupled to one of the plurality of cells configured to minimize the energy output of the plurality of cells in the event of a short circuit to an external device coupled to the battery pack assembly.

9. The battery pack assembly of claim 1 further including one or more fuses coupled to one of the plurality of cells configured to prevent an energy output from any of the plurality of cells in the event of a short circuit to an external device coupled to the battery pack assembly.

10. The battery pack assembly of claim 1 in which the battery pack assembly meets the requirements of a UL 913.

11. The battery pack assembly of claim 1 in which each of the plurality of cells meets the requirements of UL 913.

12. The battery pack assembly of claim 11 in which each of the plurality of cells is made of nickel cadmium.

13. The battery pack assembly of claim 1 in which said plurality of cells includes six cells.

14. The battery pack assembly of claim 1 in which the intrinsically safe device includes a flame ionization detector device.

15. The battery pack assembly of claim 1 in which the intrinsically safe device includes a gas chromatography device.

16. The battery pack assembly of claim 1 in which the intrinsically safe device includes a photoionization device.

17. A battery pack assembly for an intrinsically safe device comprising:
a housing assembly;
a pair of opposing end caps coupled to the housing assembly, each end cap including a stepped recess configured to align a plurality of cells in a predetermined orientation;
a potting compound disposed in the housing which completely encapsulates all the surfaces of the plurality of cells and which provides a uniform thickness of potting compound about the cells; and
wherein the potting compound is configured to dissipate heat generated by an internal short of one of the plurality of cells and/or heat generated by over-charging or under-charging one of said cells such that the temperature of any external surface of the battery pack assembly does not exceed a predetermined temperature and prevents a venting of one of the plurality cells within the potting compound.

18. The battery pack assembly of claim 17 in which the stepped recess forms a cavity proximate the ends of each of the plurality of cells configured to receive the potting compound such that the potting compound completely encapsulates the ends of each of the plurality of cells.

19. A method for manufacturing a battery pack assembly for an intrinsically safe device comprising:
providing a housing assembly;
placing a plurality of cells between opposing end caps such that the plurality of cells are aligned in a predetermined orientation;
placing the plurality of cells and the opposing end cap in the housing assembly;
pouring a potting compound in the housing assembly such that the potting compound completely encapsulates all surfaces of the plurality of cells and provides a uniform thickness of potting compound about the cells;
wherein the potting compound is configured to dissipate heat generated by an internal short of one of the plurality of cells and/or heat generated by over-charging or under-charging one of the plurality of cells such as the temperature such that the temperature of any external surface of the battery pack assembly does not exceed a predetermined temperature
curing the potting compound for a predetermined amount of time; and
attaching a cover plate to the housing assembly.

20. The method of claim 1 further including the step of forming a stepped recess in each of the opposing end caps.

21. The method of claim 18 further including the step of forming a cavity proximate the ends of each of the plurality of cells configured to receive the potting compound such that the potting compound completely encapsulates the ends of each of the plurality of cells.
